(19) United States
(12) Patent Application Publication
(10) Pub. No.: US 2024/0330795 A1
(43) Pub. Date: Oct. 3, 2024

(54) PERSONAL PROXY REPRESENTATION LOGISTICS AND DELEGATION WITHIN TALENT MANAGEMENT ENVIRONMENTS

(71) Applicant: International Business Machines Corporation, Armonk, NY (US)

(72) Inventors: Fang Lu, Billerica, MA (US); JOHN RUSSELL GERBERICH, Palatine, IL (US); Jana H. Jenkins, Raleigh, NC (US); Jeremy R. Fox, Georgetown, TX (US)

(21) Appl. No.: 18/192,748

(22) Filed: Mar. 30, 2023

(51) Int. Cl. G06Q 10/0631

(52) U.S. Cl. CPC G06Q 10/063112

(57) ABSTRACT

In an approach for selecting an individual or a group of individuals to serve as proxy for a user at a proper time and place, a processor analyzes an activity of a user and a criticality of completing the activity. Responsive to determining a proxy should represent the user in completing the activity, a processor derives a content-relevant score for each potential proxy of a plurality of potential proxies associated with the user using a scoring model. A processor selects a potential proxy with the highest content-relevant score to serve as proxy for the user while completing the activity. A processor outputs an alert notification to the potential proxy selected, wherein the alert notification contains a set of critical data to enable the potential proxy to complete the activity.

### BACKGROUND OF THE INVENTION

The present invention relates generally to the field of data processing, and more particularly to personal proxy representation logistics and delegation within talent management environments.

A personal proxy is an individual authorized to act on behalf of another individual to achieve a goal. A personal proxy may act on behalf of another individual when the individual lacks a set of skills to achieve the goal.

Talent management refers to a methodically organized, strategic process of identifying skill gaps and vacant positions, recruiting individuals who possess a set of skills to fill the skill gaps and vacant positions, enabling the individuals to grow within the system, and engaging, retaining, and motivating the individuals to achieve long-term goals. It is thus a process of getting the right individual onboard and enabling the individual to enable the business at large.

### SUMMARY

Aspects of an embodiment of the present invention disclose a method, computer program product, and computer system for selecting an individual or a group of individuals to serve as proxy for a user at a proper time and place. A processor analyzes an activity of a user and a criticality of completing the activity. Responsive to determining a proxy should represent the user in completing the activity, a processor derives a content-relevant score for each potential proxy of a plurality of potential proxies associated with the user using a scoring model. A processor selects a potential proxy with the highest content-relevant score to serve as proxy for the user while completing the activity. A processor outputs an alert notification to the potential proxy selected, wherein the alert notification contains a set of critical data to enable the potential proxy to complete the activity.

In some aspects of an embodiment of the present invention, the user is an individual, a business, or an organization.

In some aspects of an embodiment of the present invention, the activity is an action taken by a user to achieve a goal, and wherein the criticality of completing the activity is defined by a set of health data of the user or a set of personal data of the user.

In some aspects of an embodiment of the present invention, the content-relevant score is derived based on one or more of a degree of familiarity between the user and each potential proxy, a method of communication each potential proxy uses to receive a notification, a type of information the user communicates with each potential proxy, and a frequency of communication between the user and each potential proxy.

In some aspects of an embodiment of the present invention, a processor receives a goal, one or more attributes associated with each potential proxy, or one or more entities associated with each potential proxy. A processor defines a degree of priority of each potential proxy using the goal, the one or more attributes associated with each potential proxy, and the one or more entities associated with each potential proxy.

In some aspects of an embodiment of the present invention, a processor decomposes the one or more attributes and the one or more entities using a hierarchy structure. A processor compares the one or more entities within a third group. A processor compares the one or more entities within the third group of a same degree of priority to the one or more entities within a fourth group. A processor compares the one or more entities of the same priority that have not been compared.

In some aspects of an embodiment of the present invention, a processor offloads a proxy identification and selection process to a representative in a time zone determined to be available.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of an intelligent proxy identification program, on a server within the distributed data processing environment of FIG. 1, in accordance with an embodiment of the present invention;

FIG. 3 is a flowchart illustrating, in greater detail, the operational steps of a content-relevant score calculation component of the intelligent proxy identification program, on the server within the distributed data processing environment of FIG. 1, in accordance with an embodiment of the present invention;

FIG. 4A is an exemplary diagram illustrating an organization of a ranking and non-hierarchy comparison system utilized by a scoring model, on the server within the distributed data processing environment of FIG. 1, in accordance with an embodiment of the present invention;

FIG. 4B is an exemplary diagram illustrating a definition of a degree of priority, on the server within the distributed data processing environment of FIG. 1, in accordance with an embodiment of the present invention;

FIG. 4C is an exemplary diagram illustrating a calculation of a content-relevant score, on the server within the distributed data processing environment of FIG. 1, in accordance with an embodiment of the present invention; and

FIG. 5 depicts a block diagram of components of a computing environment representing the distributed data processing environment of FIG. 1, in accordance with an embodiment of the present invention.

### DETAILED DESCRIPTION

Embodiments of the present invention recognize that managing talent is a clear and present necessity when running a business. Embodiments of the present invention recognize that managing talent can present an issue when there is a need to have one individual (i.e., a proxy) represent another individual. Embodiments of the present invention recognize that personal networks can only serve a specific purpose within a specific case. Embodiments of the present invention recognize one issue that persists is how to find a proxy with the right skills, bandwidth, knowledge, and education to meet the demands of the individual the proxy is representing. Embodiments of the present invention recognize another issue that persists is optimizing the process of finding the proxy with the right skills, bandwidth, knowledge, and education to meet the demands of the individual the proxy is representing. Therefore, embodiments of the present invention recognize the need for a system and method to represent an individual, business, or organization when decisions are required to be made. Embodiments of the present invention further recognize the need for a system and method to find an individual or a group of individuals (i.e., a proxy) to represent the individual, business, or organization knowing the constraints pertinent to time, space, scope, logistics, etc. that exist.

Embodiments of the present invention provide a system and method to intelligently identify an individual or a group of individuals (i.e., who, e.g., singular, plural, or ranked proxies) to represent a user (i.e., an individual, a business, or an organization) at a proper time and place as a proxy by mapping one or more attribute of the individual or the group of individuals to a proxy request (i.e., what). As the proxy, the individual or the group of individuals may make a decision that is required to be made or may be a delegate of critical information to be delivered to an extended group who will make the decision (i.e., a proxy decision intelligent workflow). Embodiments of the present invention further provide a system and method to manage the identification of the individual or the group of individuals as well as the logistics to enable for a fluid delivery (i.e., of the 5 W's—who, what, when, where, and why).

Implementation of embodiments of the present invention may take a variety of forms, and exemplary implementation details are discussed subsequently with reference to the Figures.

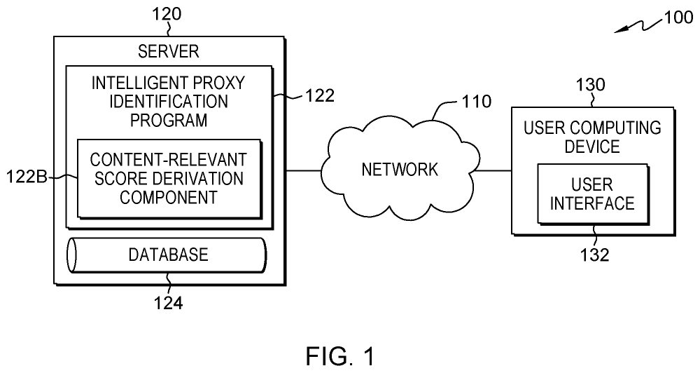

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120 and user computing device 130, and other computing devices (not shown) within distributed data processing environment 100.

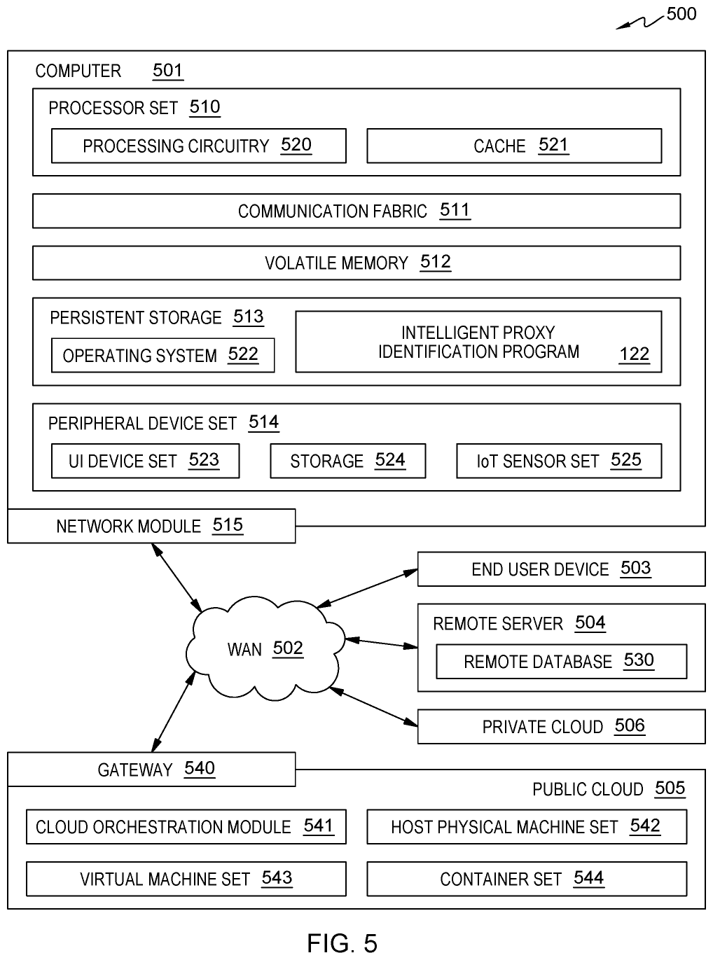

Server 120 operates to run intelligent proxy identification program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 5.

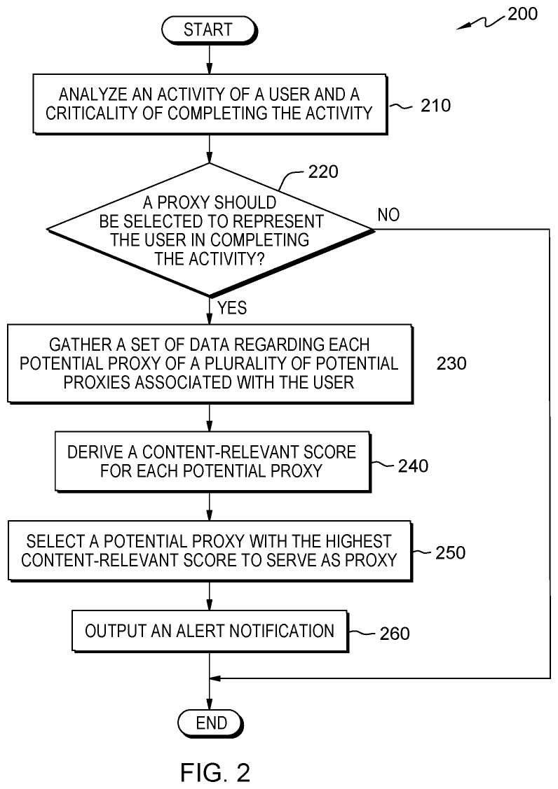

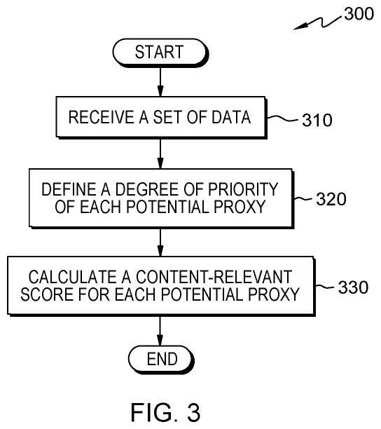

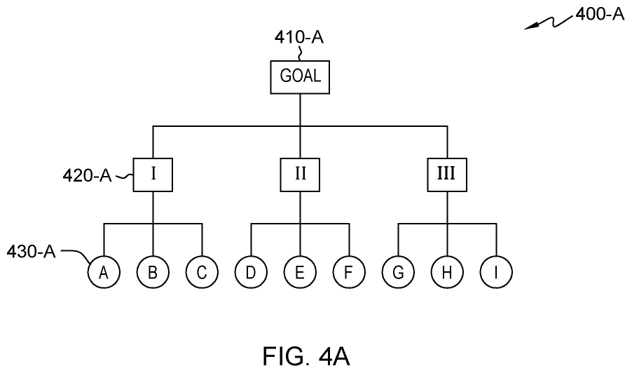

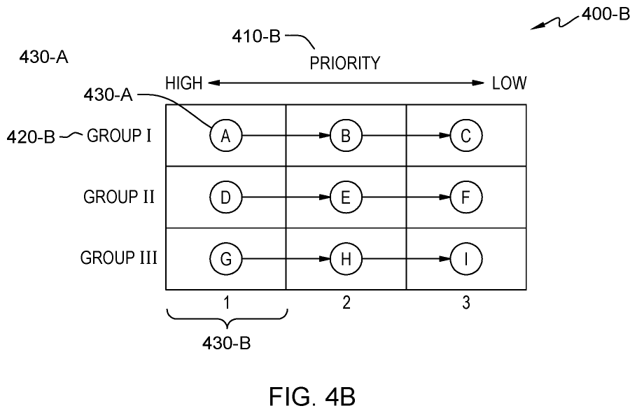

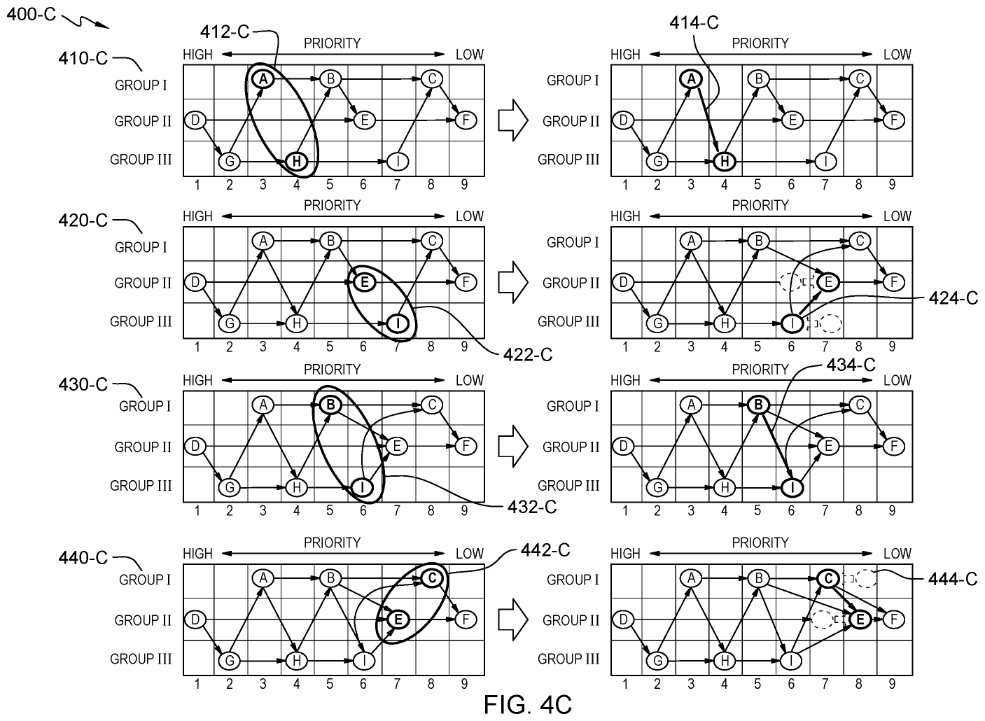

Intelligent proxy identification program 122 operates to select an individual or a group of individuals to serve as proxy for a user at a proper time and place. In the depicted embodiment, intelligent proxy identification program 122 is a standalone program. In another embodiment, intelligent proxy identification program 122 may be integrated into another software product. In the depicted embodiment, intelligent proxy identification program 122 resides on server 120. In another embodiment, intelligent proxy identification program 122 may reside on another computing device (not shown), provided that intelligent proxy identification program 122 has access to network 110. In the depicted embodiment, intelligent proxy identification program 122 contains content-relevant score calculation component 122-B. The overall operational steps of intelligent proxy identification program 122 are depicted and described in further detail with respect to FIG. 2. The operational steps of content-relevant score calculation component 122-B of intelligent proxy identification program 122 are depicted and described in further detail with respect to flowchart 300 in FIG. 3. An exemplary application of content-relevant score calculation component 122-B of intelligent proxy identification program 122 is depicted and described in further detail with respect to FIG. 4A, FIG. 4B, and FIG. 4C. More specifically, an organization of a ranking and non-hierarchy comparison system utilized by content-relevant score calculation component 122-B of intelligent proxy identification program 122 is depicted and described in further detail with respect to FIG. 4A. A definition of a degree of priority is depicted and described in further detail with respect to FIG. 4B. A calculation of a content-relevant score is depicted and described in further detail with respect to FIG. 4C.

In an embodiment, the user of user computing device 130 registers with intelligent proxy identification program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via intelligent proxy identification program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by intelligent proxy identification program 122. A database is an organized collection of data. Data includes, but is not limited to, information about user preferences (e.g., general user system settings such as alert notifications for user computing device 130); information about alert notification preferences; a set of data regarding one or more factors; a set of personal data of the user; a set of health data of the user; and any other data received, used, and/or generated by intelligent proxy identification program 122.

Database 124 can be implemented with any type of device capable of storing data and configuration files that can be accessed and utilized by server 120, such as a hard disk drive, a database server, or a flash memory. In an embodiment, database 124 is accessed by intelligent proxy identification program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that intelligent proxy identification program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Intelligent proxy identification program 122 enables the authorized and secure processing of personal data.

Intelligent proxy identification program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Intelligent proxy identification program 122 provides information regarding personal and/or confidential data and the nature (e.g., type, scope, purpose, duration, etc.) of the processing. Intelligent proxy identification program 122 provides the user with copies of stored personal and/or confidential company data. Intelligent proxy identification program 122 allows the correction or completion of incorrect or incomplete personal and/or confidential data. Intelligent proxy identification program 122 allows for the immediate deletion of personal and/or confidential data.

User computing device 130 operates to run user interface 132 through which a user can interact with intelligent proxy identification program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with intelligent proxy identification program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between intelligent proxy identification program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from intelligent proxy identification program 122 to a user via network 110. User interface 132 can also display or present alerts including information (such as graphics, text, and/or sound) sent from intelligent proxy identification program 122 to a user via network 110. In an embodiment, user interface 132 can send and receive data (i.e., to and from intelligent proxy identification program 122 via network 110, respectively). Through user interface 132, a user can opt-in to intelligent proxy identification program 122; input information about the user; create a user profile; set user preferences and alert notification preferences; receive a request for feedback; and input feedback.

A user preference is a setting that can be customized for a particular user. A set of default user preferences are assigned to each user of intelligent proxy identification program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of intelligent proxy identification program 122.

FIG. 2 is a flowchart, generally designated 200, illustrating the operational steps for intelligent proxy identification program 122, on server 120 within distributed data processing environment 100 of FIG. 1, in accordance with an embodiment of the present invention. In an embodiment, intelligent proxy identification program 122 operates to select an individual or a group of individuals to serve as proxy for a user at a proper time and place. The individual or the group of individuals considered to be selected to serve as proxy for the user at the proper time and place may hereinafter be referred to as a “potential proxy” or a “group of potential proxies”. It should be appreciated that the process depicted in FIG. 2 illustrates one possible iteration of the process flow, which may be repeated as needed. In an embodiment, intelligent proxy identification program 122 may predefine a process end time to select the potential proxy. In an embodiment, intelligent proxy identification program 122 may take into consideration one or more factors relevant to the situation to repeat the process as needed.

In step 210, intelligent proxy identification program 122 analyzes an activity of a user. In an embodiment, intelligent proxy identification program 122 analyzes an activity of the user by analyzing a location of the user. In an embodiment, intelligent proxy identification program 122 determines a criticality of completing the activity of the user by gathering personal data and heath data of the user. A user may include, but is not limited to, an individual, a business, and an organization. An activity may include, but is not limited to, an action to be taken by the user (i.e., with the assistance of a proxy) to achieve a goal. A criticality of completing the activity may be defined by, but is not limited to, a set of personal data of the user and a set of health data of the user. A set of personal data of the user may include, but is not limited to, a first and last name of the user, a business name of the user, a date of birth of the user, a home address of the user (i.e., street, zip, postal code, city), a business address of the user (i.e., street, zip, postal code, city), an e-mail address of the user, a phone number of the user, and a photo of the user. A set of health data of the user may include, but is not limited to, a first and last name of the user, a date of birth of the user, a set of vital signs of the user (i.e., body temperature, pulse rate, respiration rate, blood pressure), a head-to-toe assessment of the user, a medical treatment undergone by the user, an outcome of the medical treatment undergone by the user, a medical test undergone by the user, and a test result of the medical test undergone by the user. In an embodiment, intelligent proxy identification program 122 gathers the set of personal data of the user and the set of health data of the user from a knowledge corpus (e.g., database 124). In another embodiment, intelligent proxy identification program 122 gathers the set of personal data of the user and the set of health data of the user from an external data source (e.g., an e-mail, a text message, a social networking platform communication of the user). In an embodiment, intelligent proxy identification program 122 processes the set of personal data of the user and the set of health data of the user from the external data source. In an embodiment, intelligent proxy identification program 122 stores the set of personal data of the user and the set of health data of the user from the external data source in a knowledge corpus (e.g., database 124).

In decision step 220, intelligent proxy identification program 122 determines whether a proxy should be selected to represent the user in completing the activity. In an embodiment, intelligent proxy identification program 122 determines whether a proxy should be selected to represent the user in completing the activity based on one or more factors. The one or more factors may include, but are not limited to, a degree of urgency of completing the activity (e.g., an amount of time remaining to complete the activity), a degree of severity of completing the activity (e.g., a seriousness of completing the activity), and a degree of difficulty of completing the activity. In an embodiment, intelligent proxy identification program 122 analyzes whether a set of critical information was previously shared with an extended group of individuals associated with the user (e.g., via an alert notification). The extended group of individuals associated with the user may hereinafter be referred to as the “extended group”. The extended group may include, but is not limited to, a family member of the user, a friend of the user, and a member of the extended social network of the user. In an embodiment, responsive to determining the set of critical information was not previously shared with the extended group, intelligent proxy identification program 122 analyzes whether a set of critical information should be shared with the extended group. In an embodiment, responsive to determining the set of critical information should be shared with the extended group, intelligent proxy identification program 122 analyzes whether the user pre-selected an individual to represent the user in completing the activity. If a proxy should be selected to represent the user in completing the activity (decision step 220, YES branch), then intelligent proxy identification program 122 proceeds to step 230, gathering a set of data regarding each potential proxy of a plurality of potential proxies associated with the user. If a proxy should not be selected to represent the user in completing the activity (decision step 220, NO branch), then intelligent proxy identification program 122 ends.

In step 230, intelligent proxy identification program 122 gathers a set of data. In an embodiment, intelligent proxy identification program 122 gathers a set of data regarding each potential proxy of a plurality of potential proxies associated with the user. In an embodiment, intelligent proxy identification program 122 gathers a set of data from a knowledge corpus (e.g., database 124). In another embodiment, intelligent proxy identification program 122 gathers a set of data from an external data source (e.g., an e-mail, a text message, a social networking platform communication). In an embodiment, intelligent proxy identification program 122 processes the set of data from the external data source. In an embodiment, intelligent proxy identification program 122 stores the set of data from the external data source in a knowledge corpus (e.g., database 124). The set of data may include, but is not limited to, one or more factors to be used in the selection of the proxy. The one or more factors may include, but are not limited to, a degree of familiarity between the user and each potential proxy (i.e., a social relationship of each potential proxy), a method of communication each potential proxy uses to receive a notification (i.e., a social collaboration of each potential proxy), a type of information the user communicates with each potential proxy (i.e., a communication pattern between the user and each potential proxy), and a frequency of communication between the user and each potential proxy (i.e., a frequency definition and a frequency expectation). The method of communication may include, but is not limited to, verbal communication (i.e., when two or more individuals engage in speaking with each other or with others, e.g., over the telephone) and written communication (e.g., an email, a memo, a report, a social media post). In an embodiment, intelligent proxy identification program 122 outputs a proxy request to content-relevant score calculation component 122-B of intelligent proxy identification program 122. In an embodiment, intelligent proxy identification program 122 outputs a proxy request to content-relevant score calculation component 122-B to derive a content-relevant score for each potential proxy.

In step 240, intelligent proxy identification program 122 derives a content-relevant score. In an embodiment, intelligent proxy identification program 122 derives a content-relevant score for each potential proxy. In an embodiment, intelligent proxy identification program 122 derives a content-relevant score using a scoring model. The scoring model utilizes a ranking and non-hierarchy comparison system. The scoring model utilizes the set of data regarding each potential proxy of a plurality of potential proxies associated with the user (i.e., gathered in step 230). In an embodiment, intelligent proxy identification program 122 derives a content-relevant score to enable the selection process of the individual to serve as proxy for the user at the proper time and place. Step 240 is described in further detail with respect to flowchart 300 in FIG. 3. An exemplary application of step 240 is depicted and described in further detail with respect to FIG. 4A, FIG. 4B, and FIG. 4C.

In step 250, intelligent proxy identification program 122 selects a potential proxy with the highest content-relevant score to serve as proxy for the user while completing the activity. In another embodiment, intelligent proxy identification program 122 selects a plurality of potential proxies with a content-relevant score exceeding a pre-determined threshold to serve as proxy for the user while completing the activity. In another embodiment, intelligent proxy identification program 122 selects and ranks a plurality of potential proxies based on the content-relevant score derived for each potential proxy to serve as proxy for the user while completing the activity. In an embodiment, when selecting the proxy, intelligent proxy identification program 122 considers a duration of time the potential proxy is required for cohort involvement and collaboration. In an embodiment, when selecting the proxy, intelligent proxy identification program 122 considers a location where the potential proxy is required for cohort involvement and collaboration. In an embodiment, when selecting the potential proxy, intelligent proxy identification program 122 considers an availability of the potential proxy to accommodate the duration of time and the location where the potential proxy is required for cohort involvement and collaboration (i.e., temporal based logistics based on an availability of the potential proxy). In an embodiment, intelligent proxy identification program 122 manages the temporal based logistics involved in the selection of the potential proxy. By managing the temporal based logistics, intelligent proxy identification program 122 enables a proxy identification and selection process at any hour of a day in a global time zone pertinent to the selection. In an embodiment, based on the urgency, severity, and importance of completing the activity, intelligent proxy identification program 122 offloads a proxy identification and selection process to a representative in a time zone determined to be available (i.e., prepared to identify and select a proxy). The factors involved in the decision to offload the proxy identification and selection process to a representative in another time zone may dynamically change.

In step 260, intelligent proxy identification program 122 outputs an alert notification to the proxy selected. In another embodiment, intelligent proxy identification program 122 outputs an alert notification to a plurality of proxies selected. In an embodiment, intelligent proxy identification program 122 outputs an alert notification to the proxy selected via a user interface (e.g., user interface 132) of a user computing device (e.g., user computing device 130). The alert notification may contain, but is not limited to, a set of critical data to enable the proxy or the plurality of proxies selected to complete the activity.

FIG. 3 is a flowchart, generally designated 300, illustrating, in greater detail, the operational steps of content-relevant score calculation component 122-B (e.g., step 240) of intelligent proxy identification program 122 (hereinafter may be referred to as “content-relevant score calculation component 122-B”) on server 120 within distributed data processing environment 100 of FIG. 1, in accordance with an embodiment of the present invention. In an embodiment, content-relevant score calculation component 122-B operates to calculate a content-relevant score for each potential proxy using a scoring model to rank and compare each potential proxy. It should be appreciated that the process depicted in FIG. 3 illustrates one possible iteration of the process flow, which may be repeated as needed.

In step 310, content-relevant score calculation component 122-B receives a proxy request (i.e., output in step 230). The proxy request may include, but is limited to, a goal of the proxy request, one or more attributes, and one or more entities. A goal of the proxy request is, broadly, a field of talent management being considered and/or, more specifically, an activity to be completed. An activity is a particular scope and/or decision being considered. An activity is a particular action to be taken by the user (i.e., with the assistance of a proxy) to achieve the goal. An attribute is a skill required to achieve the goal. An entity is a distinct aspect of the attribute. For example, content-relevant score calculation component 122-B receives a proxy request. The proxy request contains a goal of the proxy request, one or more attributes, and one or more entities. The goal of the proxy request is to book a medical appointment for a user. An attribute is access to the internet to book the medical appointment. An entity is a smart phone that can be used to access the internet. Another entity is a laptop computer that can be used to access the internet. In an embodiment, content-relevant score calculation component 122-B organizes the set of data of the proxy request in a ranking and non-hierarchy comparison system as shown in FIG. 4A. A goal is shown in Level 1 of the system (e.g., 410-A). An attribute is shown in Level 2 of the system (e.g., 420-A). An entity is shown in Level 3 of the system (e.g., 430-A).

In step 320, content-relevant score calculation component 122-B defines a degree of priority. In an embodiment, content-relevant score derivation component 122-B defines a degree of priority (e.g., 410-B) of each potential proxy within a group (e.g., 420-B). The group (e.g., 420-B) may consist of a potential proxy or a group of potential proxies being considered to complete the activity. In an embodiment, content-relevant score derivation component 122-B separates the entities (e.g., 430-B) of the group (e.g., 420-B) into equally divided columns as shown in FIG. 4B.

In step 330, content-relevant score calculation component 122-B calculates a content-relevant score for each potential proxy. In an embodiment, content-relevant score derivation component 122-B compares entities of an equal or near equal degree of priority but of different groups as shown in FIG. 4C. For example, the scoring model compares entity A of Group I and entity H of Group III (i.e., 412-C) in chart 410-C. A and H have nearly equal degrees of priority but are found in different groups. The comparison process relates back to the skill required to achieve the goal. Content-relevant score calculation component 122-B is based on the logic that if A is more important than B and B is more important than C, then A is logically more important than C. Thus, one can assign logical priorities to one or more entities using a relatively small number of comparisons. The assignment of logical priorities to the one or more entities can be completed via the following process steps: (1) decomposing one or more attributes using a hierarchy structure and then for one or more entities in the lowest level; (2) comparing the one or more entities within the same group; (3) comparing the one or more entities of the same priority between different groups (e.g., entity A of Group I and entity H of Group III (i.e., 412-C) in chart 410-C; entity E of Group II and entity F of Group III (i.e., 422-C) in chart 420-C; entity B of Group I and entity I of Group III (i.e., 432-C) in chart 430-C; entity C of Group I and entity E of Group II (i.e., 442-C) in chart 440-C); and (4) comparing the one or more entities of adjoined priorities that have not been compared. The final assignment of logical priorities to the plurality of entities is, for example, shown in FIG. 4C at 414-C, 424-C, 434-C, and 444-C. Content-relevant score calculation component 122-B yields the scoring value for different groups being considered for the talent selection process within the proxy selection. The higher the scoring value, the more relevant the group being considered for the talent selection process within the proxy selection.

FIG. 4A is an exemplary diagram, generally designated 400-A, illustrating an organization of a ranking and non-hierarchy comparison system utilized by a scoring model, on server 120 within distributed data processing environment 100 of FIG. 1, in accordance with an embodiment of the present invention.

FIG. 4B is an exemplary diagram, generally designated 400-B, illustrating a definition of a degree of priority, on server 120 within distributed data processing environment 100 of FIG. 1, in accordance with an embodiment of the present invention.

FIG. 4C is an exemplary diagram, generally designated 400-C, illustrating a calculation of a content-relevant score, on server 120 within distributed data processing environment 100 of FIG. 1, in accordance with an embodiment of the present invention.

In a first example, intelligent proxy identification program 122 enables the user, who is a senior citizen without access to a computer, to have a proxy, who is a child of the user, book a medical appointment and provide a medical proxy to enable said booking. Intelligent proxy identification program 122 analyzes and determines that the senior citizen is in a high-risk cohort for a certain disease or condition. Intelligent proxy identification program 122 checks the record and determines the user has not gotten an available vaccine for a disease. Intelligent proxy identification program 122 determines that the child communicates with the user on the phone regularly. Intelligent proxy identification program 122 recommends that the child get consent from the user to schedule a medical appointment for the user. The child follows guidance provided by intelligent proxy identification program 122 to obtain the necessary consent to book the medical appointment for the user.

In a second example, family, friends, and relevant people in a user's life may not be reached easily during an emergency situation. Intelligent proxy identification program 122 uses a set of contact information from a phone of a user or another communication method of the user to retrieve a list of contact information with the consent of the user. Intelligent proxy identification program 122 uses location services on the phone of the user to detect the location of the contacts of the user. Intelligent proxy identification program 122 calls and/or texts the contacts of the user if intelligent proxy identification program 122 determines the contacts are located in a safe zone. Intelligent proxy identification program 122 facilitates inquiry about the safety status of the contacts of the user. Intelligent proxy identification program 122 asks those in dangerous situations whether they can confirm which contact can be a trusted delegation for handling specific actions pertaining to personal information, for example, for retrieving certain information on their behalf.

FIG. 5 depicts a block diagram of components of server 120 within distributed data processing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Computing environment 500 contains an example of an environment for the execution of at least some of the computer code involved in performing the inventive methods, such as intelligent proxy identification program 122. In addition to intelligent proxy identification program 122, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and intelligent proxy identification program 122, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in intelligent proxy identification program 122 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in intelligent proxy identification program 122 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
analyzing, by one or more processors, an activity of a user and a criticality of completing the activity;
responsive to determining a proxy should represent the user in completing the activity, deriving, by the one or more processors, a content-relevant score for each potential proxy of a plurality of potential proxies associated with the user using a scoring model;
selecting, by the one or more processors, a potential proxy with the highest content-relevant score to serve as proxy for the user while completing the activity; and
outputting, by the one or more processors, an alert notification to the potential proxy selected, wherein the alert notification contains a set of critical data to enable the potential proxy to complete the activity.

2. The computer-implemented method of claim 1, wherein the user is an individual, a business, or an organization.

3. The computer-implemented method of claim 1, wherein the activity is an action taken by a user to achieve a goal, and wherein the criticality of completing the activity is defined by a set of health data of the user or a set of personal data of the user.

4. The computer-implemented method of claim 1, wherein the content-relevant score is derived based on one or more of a degree of familiarity between the user and each potential proxy, a method of communication each potential proxy uses to receive a notification, a type of information the user communicates with each potential proxy, and a frequency of communication between the user and each potential proxy.

5. The computer-implemented method of claim 1, wherein deriving the content-relevant score for each potential proxy of the plurality of potential proxies associated with the user using the scoring model further comprises:
receiving, by the one or more processors, a goal, one or more attributes associated with each potential proxy, or one or more entities associated with each potential proxy; and
defining by the one or more processors, a degree of priority of each potential proxy using the goal, the one or more attributes associated with each potential proxy, and the one or more entities associated with each potential proxy.

6. The computer-implemented method of claim 5, wherein defining the degree of priority of each potential proxy using the goal, the one or more attributes associated with each potential proxy, and the one or more entities associated with each potential proxy further comprises:
decomposing, by the one or more processors, the one or more attributes and the one or more entities using a hierarchy structure;
comparing, by the one or more processors, the one or more entities within a third group;
comparing, by the one or more processors, the one or more entities within the third group of a same degree of priority to the one or more entities within a fourth group; and
comparing, by the one or more processors, the one or more entities of the same priority that have not been compared.

7. The computer-implemented method of claim 1, wherein deriving the content-relevant score for each potential proxy of the plurality of potential proxies associated with the user using the scoring model further comprises:
offloading, by the one or more processors, a proxy identification and selection process to a representative in a time zone determined to be available.

8. A computer program product comprising:
one or more computer readable storage media and program instructions stored on the one or more computer readable storage media, the program instructions comprising:
program instructions to analyze an activity of a user and a criticality of completing the activity;
responsive to determining a proxy should represent the user in completing the activity, program instructions to derive a content-relevant score for each potential proxy of a plurality of potential proxies associated with the user using a scoring model;
program instructions to select a potential proxy with the highest content-relevant score to serve as proxy for the user while completing the activity; and
program instructions to output an alert notification to the potential proxy selected, wherein the alert notification contains a set of critical data to enable the potential proxy to complete the activity.

9. The computer program product of claim 8, wherein the user is an individual, a business, or an organization.

10. The computer program product of claim 8, wherein the activity is an action taken by a user to achieve a goal, and wherein the criticality of completing the activity is defined by a set of health data of the user or a set of personal data of the user.

11. The computer program product of claim 8, wherein the content-relevant score is derived based on one or more of a degree of familiarity between the user and each potential proxy, a method of communication each potential proxy uses to receive a notification, a type of information the user communicates with each potential proxy, and a frequency of communication between the user and each potential proxy.

12. The computer program product of claim 8, wherein deriving the content-relevant score for each potential proxy of the plurality of potential proxies associated with the user using the scoring model further comprises:
program instructions to receive a goal, one or more attributes associated with each potential proxy, or one or more entities associated with each potential proxy; and
program instructions to define a degree of priority of each potential proxy using the goal, the one or more attributes associated with each potential proxy, and the one or more entities associated with each potential proxy.

13. The computer program product of claim 12, wherein defining the degree of priority of each potential proxy using the goal, the one or more attributes associated with each potential proxy, and the one or more entities associated with each potential proxy further comprises:
program instructions to decompose the one or more attributes and the one or more entities using a hierarchy structure;
program instructions to compare the one or more entities within a third group;
program instructions to compare the one or more entities within the third group of a same degree of priority to the one or more entities within a fourth group; and
program instructions to compare the one or more entities of the same priority that have not been compared.

14. The computer program product of claim 8, wherein deriving the content-relevant score for each potential proxy of the plurality of potential proxies associated with the user using the scoring model further comprises:
program instructions to offload a proxy identification and selection process to a representative in a time zone determined to be available.

15. A computer system comprising:
one or more computer processors;
one or more computer readable storage media;
program instructions collectively stored on the one or more computer readable storage media for execution by at least one of the one or more computer processors, the stored program instructions comprising:
program instructions to analyze an activity of a user and a criticality of completing the activity;
responsive to determining a proxy should represent the user in completing the activity, program instructions to derive a content-relevant score for each potential proxy of a plurality of potential proxies associated with the user using a scoring model;
program instructions to select a potential proxy with the highest content-relevant score to serve as proxy for the user while completing the activity; and
program instructions to output an alert notification to the potential proxy selected, wherein the alert notification contains a set of critical data to enable the potential proxy to complete the activity.

16. The computer system of claim 15, wherein the user is an individual, a business, or an organization.

17. The computer system of claim 15, wherein the activity is an action taken by a user to achieve a goal, and wherein the criticality of completing the activity is defined by a set of health data of the user or a set of personal data of the user.

18. The computer system of claim 15, wherein the content-relevant score is derived based on one or more of a degree of familiarity between the user and each potential proxy, a method of communication each potential proxy uses to receive a notification, a type of information the user communicates with each potential proxy, and a frequency of communication between the user and each potential proxy.

19. The computer system of claim 15, wherein deriving the content-relevant score for each potential proxy of the plurality of potential proxies associated with the user using the scoring model further comprises:
program instructions to receive a goal, one or more attributes associated with each potential proxy, or one or more entities associated with each potential proxy; and
program instructions to define a degree of priority of each potential proxy using the goal, the one or more attributes associated with each potential proxy, and the one or more entities associated with each potential proxy.

20. The computer system of claim 19, wherein defining the degree of priority of each potential proxy using the goal, the one or more attributes associated with each potential proxy, and the one or more entities associated with each potential proxy further comprises:
program instructions to decompose the one or more attributes and the one or more entities using a hierarchy structure;
program instructions to compare the one or more entities within a third group;
program instructions to compare the one or more entities within the third group of a same degree of priority to the one or more entities within a fourth group; and
program instructions to compare the one or more entities of the same priority that have not been compared.
